(19) United States
(12) Patent Application Publication
(10) Pub. No.: US 2017/0075192 A1
(43) Pub. Date: Mar. 16, 2017

(54) INSULATION OF COMPONENTS OF AN SMA ACTUATION ARRANGEMENT IN A MINIATURE CAMERA

(71) Applicants: CAMBRIDGE MECHATRONICS LIMITED, Cambridge, Cambridgeshire (GB); HUTCHINSON TECHNOLOGY INCORPORATED, Hutchinson, MN (US)

(72) Inventors: Benjamin BROWN, Cambridge (GB); Peter Francis LADWIG, Hutchinson, MN (US); Paul Valentine PESAVENTO, Hutchinson, MN (US); Todd Austin PETER, Hutchinson, MN (US)

(73) Assignees: CAMBRIDGE MECHATRONICS LIMITED, Cambridge, Cambridgeshire (GB); HUTCHINSON TECHNOLOGY INCORPORATED, Hutchinson, MN (US)

(21) Appl. No.: 15/123,532

(22) PCT Filed: Mar. 2, 2015
(86) PCT No.: PCT/GB2015/050599

§ 371 Date: Sep. 2, 2016

(30) Foreign Application Priority Data
Mar. 4, 2014 (GB) 1403803.8

(51) Int. Cl. G03B 5/04; G02B 7/04; F03G 7/06; G03B 13/32; H04N 5/232; H04N 5/225; G02B 27/64; G02B 13/00

(52) U.S. Cl. CPC G03B 5/04; G02B 27/646; G02B 7/04; G02B 13/001; G03B 13/32; H04N 5/23287; H04N 5/2253; H04N 5/23258; F03G 7/065; G03B 2205/0015; G03B 2205/0076

(57) ABSTRACT

Insulation of components of an SMA actuation arrangement in a miniature camera A miniature camera comprises an SMA actuator arrangement including at least one SMA actuator wire arranged to effect focus, zoom or optical image stabilization. At least one component of the SMA actuator arrangement that is not the SMA actuator wire is coated with an electrically insulating layer, thereby reducing the risk of short circuiting of the drive current of the SMA actuator wire. The SMA actuator wire may not be coated at all.

The present invention relates to an SMA (shape memory alloy) actuation arrangement using SMA actuator wires to effect focus, zoom or optical image stabilization in a miniature camera.

SMA actuator wires are known for use in miniature cameras to effect focus, zoom or optical image stabilization (OIS), as disclosed for example in WO-2013/175197 and WO-2014/083318.

For such miniature applications, it is desirable to make the components as small as possible. This can lead to a possible problem if the SMA actuator wire is located very close to other components in the device, especially metallic components. If the SMA actuator wire comes into contact with a metal surface that is at a different potential to the SMA actuator wire, then a short circuit can occur. This can cause local heating on the surface of the wire that can lead to damage or even local melting, such that the SMA actuator wire is weakened which in turn can lead to reduced performance or in the worst case fractures that lead to breakage.

To alleviate this problem, one solution is to maintain relatively high clearances, but this increases the size of the camera.

Another solution to this problem that has been considered by the inventors is to coat the SMA actuator wire with an electrically insulating layer, for example as described in co-pending International Patent Application No. PCT/GB2014/052754. However, with this approach, given that the electrically insulating layer will typically have a relatively low thermal conductivity, careful selection of the thickness of the electrically insulating layer is needed to maximise the rate of cooling and hence the speed of extension of the SMA actuator wire, which is important in a miniature camera to provide a rapid response. For example, in an OIS application, rapid heating and cooling of the wire is necessary to compensate for handshake, which typically occurs at frequencies up to several Hertz. A rapid response is also needed in focus and zoom applications. For this reason, there is used thin SMA actuator wire, typically having a diameter of the order of 25 μm, since thin wire heats and cools very quickly.

According to the present invention, there is provided a miniature camera comprising an SMA actuator arrangement including at least one SMA actuator wire arranged to effect focus, zoom or optical image stabilization of the miniature camera, wherein at least one component of the SMA actuator arrangement that is not the SMA actuator wire is coated with an electrically insulating layer.

The electrically insulating layer provides the advantage of providing electrical insulation that reduces the risk of a short circuit from current flowing through the SMA actuator wire and other components of the SMA actuator arrangement. Such short circuits could otherwise cause damage to the SMA actuator wires. Thus, the electrically insulating layer may allow the SMA actuator wire to be arranged with smaller clearances that may reduce the overall size of the miniature camera.

In general, any component in close proximity to the SMA actuator wire is coated with an insulating layer. The coated components are typically made of a conductive material (e.g. metal), although non-conductive components may also be coated.

The electrically insulating layer is provided with sufficient thickness to provide electrical insulation, which may depend on the location of the component that is coated. Typically, the thickness of the electrically insulating layer is less than 3 μm, or less than 1 μm.

By providing the electrical insulation on components other than the SMA actuator wire itself, the need to coat the SMA actuator wire is reduced. In some miniature cameras, the SMA actuator wire may not be coated with an electrically insulating layer. This provides a number of advantages in manufacture of the SMA actuation arrangement. Firstly, coating other components avoids the need when coating the SMA actuator wire for careful selection of the thickness of the electrically insulating layer to maximise the rate of cooling and hence the speed of extension of the SMA actuator wire. Secondly, it is generally more difficult to coat the SMA actuator wire than to coat other components, because the SMA actuator wire is a thin wire that is less robust than the other components and needs careful handling to avoid mechanical damage during assembly. Thirdly, while many suitable coating processes are available for coating of the SMA actuator wire, such processes often involve heating, either during the application of the coating or more commonly during curing of the material of the electrically insulating layer. As the actuation of the SMA actuator wire is dependent on thermal cycling, there is a risk that such heating may damage the SMA actuator wire in a way that reduces its lifetime. This risk is avoided when coating components other than the SMA actuator wire.

On the other hand, in order to increase the amount of electrical insulation, in other miniature cameras, the SMA actuator wire may be coated with a further electrically insulating layer. In that case, the thickness of the further electrically insulating layer may be typically be in the range from 0.3 μm to 10 μm. As discussed in co-pending International Patent Application No. PCT/GB2014/052754, it has been appreciated that the provision of the electrically insulating layer with thickness in the range from 0.3 μm to 10 μm does not in fact reduce the rate of cooling of the SMA actuator wire, as might be expected, and may even increase the rate of cooling.

To allow better understanding, an embodiment of the present invention will now be described by way of non-limitative example with reference to the accompanying drawings, in which:

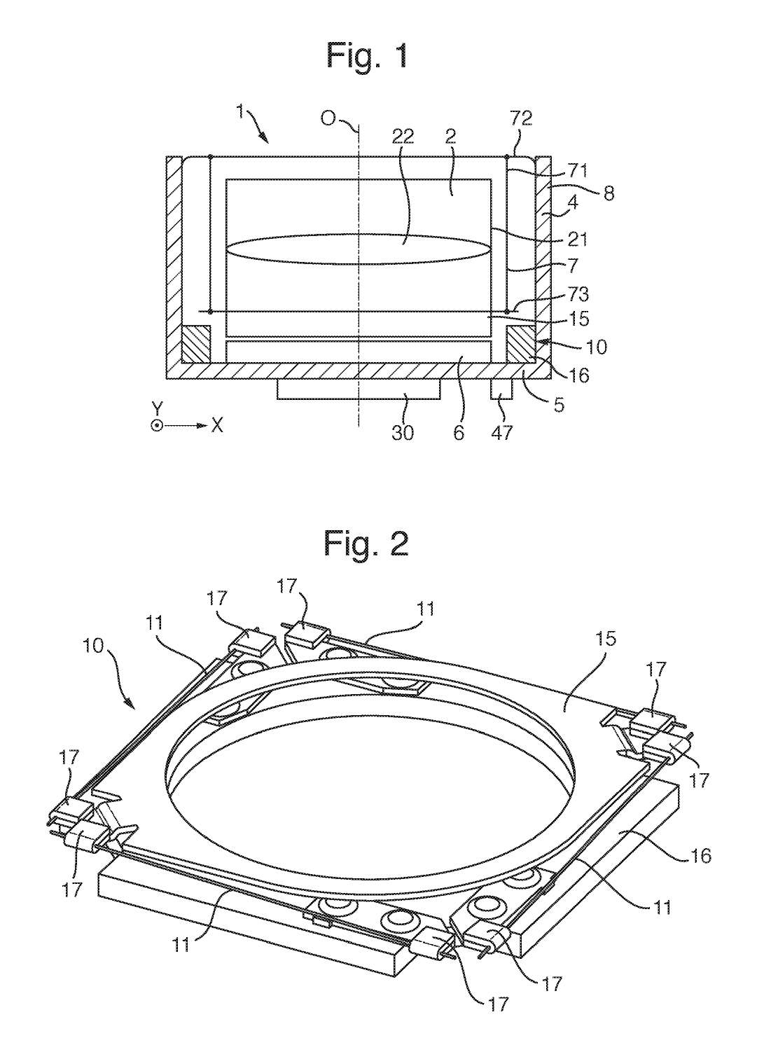

FIG. 1 is a schematic cross-sectional view of a first miniature camera;

FIG. 2 is a perspective view of the arrangement of an SMA actuator arrangement in the first miniature camera;

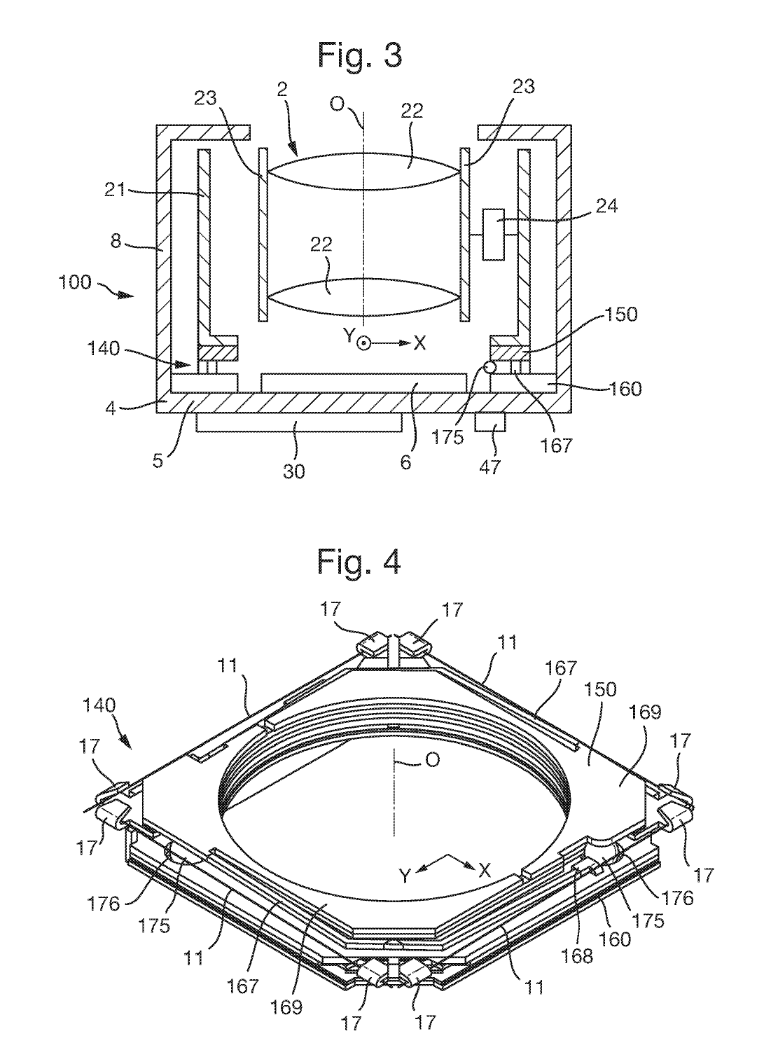

FIG. 3 is a schematic cross-sectional view of a second miniature camera;

FIG. 4 is a perspective view of the arrangement of an SMA actuator arrangement in the second miniature camera;

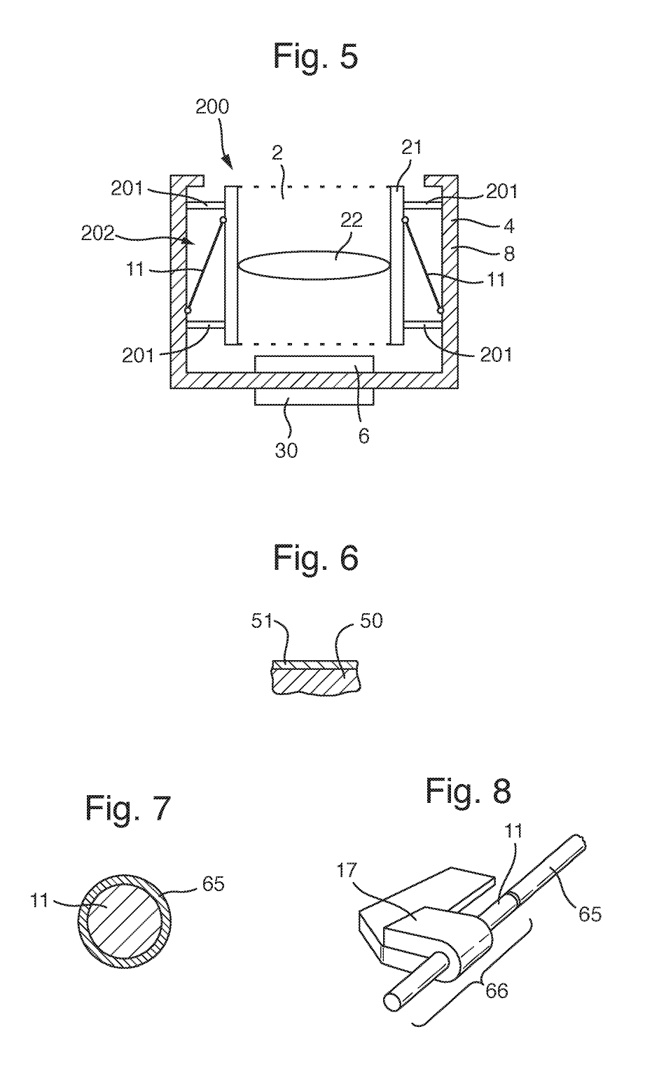

FIG. 5 is a schematic cross-sectional view of a third miniature camera;

FIG. 6 is a cross-sectional view of a coated component;

FIG. 7 is a cross-sectional view of a coated SMA actuator wire; and

FIG. 8 is a perspective view of an end portion of the coated SMA actuator wire.

There will now be described the construction of three different miniature cameras 1, 100 and 200 in which the present invention may be applied. Each of the miniature cameras 1, 100 and 200 is to be incorporated in a portable electronic device such as a mobile telephone, media player or portable digital assistant. Thus miniaturisation is an important design criterion. The miniature cameras 1, 100 and 200 share many components in common, so common components are given the same reference numerals and the description of those common components applies to all the miniature cameras 1, 100 and 200, except where differences are described.

A first miniature camera 1 is shown in FIG. 1 which is a cross-sectional view taken along the optical axis O. In the first miniature camera 1, SMA actuator wires 11 are arranged to effect optical image stabilization, although the SMA actuator wires 11 are not shown in FIG. 1, but subsequently described with reference to FIG. 2. Except as regards the provision of an electrically insulating layer, the first miniature camera 1 has the constructions described in WO-2013/175197, which is incorporated herein by reference. For brevity, a concise description of the miniature camera is provided herein, but reference is made to WO-2013/175197 for further details.

The first miniature camera 1 comprises a lens assembly 2 supported on a support assembly 4 by a suspension system 7.

The suspension system 7 comprises four beams 71 connected between a support plate 72 that forms part of the support assembly 4 and a lens plate 73 that forms part of the lens assembly 2 and is connected to the rear end of the lens carrier 21 as shown in FIG. 1. The suspension system 7 supports the lens assembly 2 in a manner allowing movement of the lens assembly 2 relative to the support assembly 4 in two orthogonal directions each perpendicular to the optical axis O.

The support assembly 4 is a camera support for supporting an image sensor 6. The support assembly 4 comprises a base 5, the image sensor being mounted on the front side of the base 5. On the rear side of the base 5 there is mounted an IC (integrated circuit) chip 30 in which a control circuit is implemented, and also a gyroscope sensor 47. The support assembly 4 also comprises a can 8 containing the SMA actuator arrangement 10 that is described below, for the purpose of encapsulating and protecting it.

The lens assembly 2 comprises a lens carrier 21 in the form of a cylindrical body supporting a lens 22 arranged along the optical axis O, although in general any number of lenses 22 may be provided. The first miniature camera 1 is a miniature camera in which the lens 22 (or lenses 22 if plural lenses are provided) has a diameter of at most 10 mm.

The lens assembly 2 is arranged to focus an image onto the image sensor 6. The image sensor 6 captures the image and may be of any suitable type, for example a CCD (charge-coupled device) or a CMOS (complimentary metal-oxide-semiconductor) device.

The lens 22 (or lenses 22 if plural lenses are provided) may be fixed relative to the lens carrier 21, or alternatively may be supported on the lens carrier in a manner in which the lens 22 (or at least one lens 22 if plural lenses are provided) is movable along the optical axis O, for example to provide focussing. Where the lens 22 is movable along the optical axis O, a suitable actuation system (not shown) may be provided, for example using a voice coil motor or SMA actuator wires, such as is described in WO-2007/113478.

In operation, the lens assembly 2 is moved orthogonally to the optical axis O in two orthogonal directions, shown as X and Y relative to the image sensor 6, with the effect that the image on the image sensor 6 is moved. This is used to provide OIS, compensating for image movement of the first miniature camera 1, caused by for example hand shake.

Movement of the lens assembly 2 is driven by an actuator arrangement 10 shown in FIG. 2, as will now be described.

The actuator arrangement 10 comprises a total of four SMA actuator wires 11 connected between a support block 16 that forms part of the support assembly 4 and is mounted to the base 5 and a movable platform 15 that forms part of the lens assembly 2 and is mounted to the rear of the lens plate 73 as shown in FIG. 1. The SMA actuator wires 11 are connected at their ends to the movable platform 15 and the support block 16 by respective crimps 17. The crimps 17 crimp the SMA actuator wires 11 to hold them mechanically, optionally strengthened by the use of adhesive. The crimps 17 also provide an electrical connection to the SMA actuator wires 11.

Each of the SMA actuator wires 11 is held in tension, thereby applying a force between the movable platform 15 and the support block 16 in a direction perpendicular to the optical axis O. In operation, the SMA actuator wires 11 move the lens assembly 2 relative to the support block 16 in two orthogonal directions perpendicular to the optical axis O.

The SMA actuator wires 11 have an arrangement around the optical axis O as follows. Each of the SMA actuator wires 11 is arranged along one side of the lens assembly 2. Thus, a first pair of the SMA actuator wires 11 arranged on opposite sides of the optical axis O are capable on selective driving to move the lens assembly 2 relative to the support assembly 4 in a first direction in said plane and a second pair of SMA actuator wires 11 arranged on opposite sides of the optical axis O. are capable on selective driving to move the lens assembly 2 relative to the support assembly 4 in a second direction in said plane transverse to the first direction. Movement in directions other than parallel to the SMA actuator wires 11 may be driven by a combination of actuation of these pairs of the SMA actuator wires 11 to provide a linear combination of movement in the transverse directions.

As a result, the SMA actuator wires 11 are capable of being selectively driven to move the lens assembly 2 relative to the support assembly 4 to any position in a range of movement in two orthogonal directions perpendicular to the optical axis O. The magnitude of the range of movement depends on the geometry and the range of contraction of the SMA actuator wires 11 within their normal operating parameters.

The position of the lens assembly 2 relative to the support assembly 4 perpendicular to the optical axis O is controlled by selectively varying the temperature of the SMA actuator wires 11. This is achieved by passing through SMA actuator wires 11 selective drive currents that provide resistive heating. Heating is provided directly by the drive current. Cooling is provided by reducing or ceasing the drive current to allow the SMA actuator wires 11 to cool by conduction, convection and radiation to its surroundings. Rapid heating and cooling of the SMA actuator wire 11 is necessary to compensate for handshake, which typically occurs at frequencies up to several Hertz. A rapid response is also needed in focus and zoom applications. For this reason, there is used thin SMA actuator wire 11, typically having a diameter of the order of 25 μm, since such thin wire heats and cools very quickly.

The control of the SMA actuator wires 11 is effected by a control circuit implemented in the IC chip 30 which generates drive signals for each of the SMA actuator wires 11 to effect OIS. The drive signals are generated on the basis of the output signal of the gyroscope sensor 47 that detects the angular velocity of the lens assembly 2, thereby acting as a vibration sensor that detects the vibrations of the first miniature camera 1.

A second miniature camera 100 is shown in FIG. 3 which is a cross-sectional view taken along the optical axis O. In the second miniature camera 100, as in the first miniature camera 1, SMA actuator wires 11 are arranged to effect optical image stabilization, although the SMA actuator wires 11 are not shown in FIG. 3, but subsequently described with reference to FIG. 4. Except as regards the provision of electrically insulating layers, the second miniature camera 100 has the construction described in WO-2014/083318, which is incorporated herein by reference. For brevity, a concise description of the miniature camera is provided herein, but reference is made to WO-2014/083318 for further details.

The second miniature camera 100 comprises a lens assembly 2 supported on a support assembly 4 by a suspension system 140 that supports the lens assembly 2 in a manner allowing movement of the lens assembly 2 relative to the support assembly 4 in two orthogonal directions each perpendicular to the optical axis O.

The support assembly 4 is a camera support for supporting an image sensor 6. The support assembly 4 comprises a base 5, the image sensor 6 being mounted on the front side of the base 5. On the rear side of the base 5 there is mounted an IC (integrated circuit) chip 30 in which a control circuit is implemented, and also a gyroscope sensor 47. The support assembly 4 also comprises a can 8 containing the SMA actuator arrangement 10 that is described below, for the purpose of encapsulating and protecting it.

The lens assembly 2 comprises a lens carrier 21 in the form of a cylindrical body supporting two lenses 22 arranged along the optical axis O, although in general any number of lenses 22 may be provided. The second miniature camera 100 is a miniature camera in which the lens 22 (or lens 22 if a single lens is provided) has a diameter of at most 10 mm.

The lens assembly 2 is arranged to focus an image onto the image sensor 6. The image sensor 6 captures the image and may be of any suitable type, for example a CCD (charge-coupled device) or a CMOS (complimentary metal-oxide-semiconductor) device.

In this example, the lenses 22 are supported on the lens carriage 21 in a manner in which the lenses 22 are movable along the optical axis O relative to the lens carriage 21, for example to provide focussing or zoom. In particular, the lenses 22 are fixed to a lens holder 23 which is movable along the optical axis O relative to the lens carriage 21. Although all the lenses 22 are fixed to the lens holder 23 in this example, in general one or more of the lenses 22 may be fixed to the lens carriage 21 and so not movable along the optical axis O relative to the lens carriage 21, leaving at least one of the lenses 22 fixed to the lens holder 23.

An axial actuation arrangement 24 provided between the lens carriage 21 and the lens holder 23 is arranged to drive movement of the lens holder 21 and lenses 22 along the optical axis O relative to the lens carriage 21. The axial actuation arrangement 24 may be any suitable type, for example being a voice coil motor (VCM) or an arrangement of SMA actuator wires, such as is described in WO-2007/113478 which is incorporated herein by reference.

In operation, the lens assembly 2 is moved orthogonally to the optical axis O in two orthogonal directions, shown as X and Y relative to the image sensor 6, with the effect that the image on the image sensor 6 is moved. This is used to provide OIS, compensating for image movement of the second miniature camera 100, caused by for example hand shake.

The suspension system 140 which forms part of an actuator arrangement 10 shown in FIG. 4 which also drives movement of the lens assembly 2, as will now be described.

The suspension system 140 comprises (a) a movable platform 150 that forms part of the camera lens assembly 2 and is connected to the lens carriage 21, and (b) a support plate 160 that forms part of the support assembly 4 and is connected to the base 5.

The movable platform 150 is supported on the support plate 160 by plural balls 175 and two flexure arms 167. The support plate 160 has recesses 175 in which respective balls 175 are located and laterally retained.

In this example, three balls 175 are provided, but in general any number of balls 175 could be provided. It is preferable to provide at least three balls 175 to prevent relative tilting of the movable platform 150 and the support plate 160. Three balls 175 are sufficient to support the support plate 160 without tilting, and the provision of three balls 175 has the advantage of easing the tolerances required to maintain point contact with each ball 175 in a common plane. It would be possible to use more than three balls, for example four balls 175, which would allow a symmetrical design.

The balls 175 act as rotary bearings allowing movement of the camera lens assembly 2 relative to the support assembly 4 orthogonal to the optical axis O. The balls 175 may be spherical or may in general be any rotary element with curved surfaces that bear against the movable platform 150 and the support plate 160 and are able to roll back and forth and around in operation.

The movable platform 150 and the support plate 160 each have a laminated construction of insulator layers and metallic layers bonded by adhesive. The insulator layers may each be made of any suitable electrically insulating material, for example a polymer material such as kapton which is a polyimide material commonly used in printed circuits. The adhesive may be in any suitable form, for example adhesive-impregnated kapton or a double sided adhesive between the bonded surfaces.

The flexure arms 167 each extend between the movable platform 150 and the support plate 160. The flexure arms 167 have a dual purpose of providing a mechanical function as described below and providing electrical connections from the support assembly 4 to the camera lens assembly 2.

Each flexure arm 167 is provided with a base fitting 168 at the static end of the flexure arm 167. The base fitting 168 is mounted to the support plate 160 and hence to the support assembly 4 as a whole. This mounting may be achieved by soldering which provides both mechanical and electrical connection.

Each flexure arm 167 is formed integrally with a moving fitting 169 at the moving end of the flexure arm 167. The moving fitting 169 is a plate that is laminated into the movable platform 150, and hence mounted to the camera lens assembly 2. The moving fitting 169 bears on the balls 175 which are thereby disposed between the support assembly 4 and the camera lens assembly 2 and act as rotary bearings.

The flexure arms 167 are arranged as follows to provide their mechanical function. Each flexure arm 167 is an elongate beam connected between the support assembly 4 and the camera lens assembly 2.

The flexure arms 167, due to their intrinsic resilience, bias the support assembly 4 and the camera lens element 20 against the balls 175, the biasing force being applied parallel to the optical axis O. This maintains the contact with the balls 175. At the same time, the flexure arms 167 may be laterally deflected to permit said movement of the camera lens assembly 2 relative to the support assembly 4 orthogonal to the optical axis O, to permit an OIS function.

The flexure arms 167, again due to their intrinsic resilience, provide a lateral biasing force that biases the camera lens assembly 2 towards a central position. As a result, in the absence of driving of the lateral movement of the camera lens assembly 2, the camera lens assembly 2 will tend towards the central position, even in the absence of driving.

The flexure arms 167 are designed as follows to provide a suitable retaining force on the balls 175 along the optical axis O and also to permit lateral movement with a lateral biasing force. The magnitude of the lateral biasing force is kept low enough as not to hinder OIS, whilst being high enough to centre the camera lens assembly 2 in the absence of driving.

Each flexure arm 167 has a cross-section with an average width orthogonal to the optical axis O is that is greater than its average thickness parallel to the optical axis O. Each flexure arm 167 extends in an L-shape around the optical axis O, it in general being desirable that the angular extent is at least 90° as measured between the ends of the flexure arm 167.

In the manufactured state of the suspension system 140, the flexure arms 167 are deflected from their relaxed state to provides a pre-loading force that biases the support assembly 4 and the camera lens assembly 2 against the balls 175.

The flexure arms 167 are made of a suitable material that provides a good bearing, provides the desired mechanical properties and is electrically conductive. Typically the material is a metal having a relatively high yield, for example steel such as stainless steel.

The actuator arrangement 10 of the second miniature camera 100 comprises a total of four SMA actuator wires 11 extending between the support plate 160 that forms part of the support assembly 4 and the movable platform 15 that forms part of the lens assembly 2, being connected thereto at their respective ends by crimps 17. The actuator arrangement 10 of the second miniature camera 100 has the same overall arrangement and operation as in the first miniature camera 1, as described above, so a description thereof is not repeated.

The control of the SMA actuator wires 11 of the second miniature camera 100 is effected by a control circuit implemented in the IC chip 30 which generates drive signals for each of the SMA actuator wires 11 to effect OIS. The drive signals are generated on the basis of the output signal of the gyroscope sensor 47 that detects the angular velocity of the lens assembly 2, thereby acting as a vibration sensor that detects the vibrations of the second miniature camera 100.

A third miniature camera 200 is shown in FIG. 5 which is a cross-sectional view taken along the optical axis O. The third miniature camera 200 includes an SMA actuator arrangement 202 including SMA actuator wires 11 arranged to effect focus or zoom of the third miniature camera 200. The third miniature camera 200 has a generally similar construction to the first miniature camera 1 shown in FIG. 1 including: the SMA actuator arrangement 202; a support assembly 4 including a can 8 containing the SMA actuator arrangement 202; a lens assembly 2 comprising a lens carrier 21 supporting a lens 22; an image sensor 6; and an IC chip 30 in which a control circuit for the SMA actuator wires is implemented. However, the lens assembly 2 is supported on the support assembly 4 by flexure arms 201 which form a suspension system that guides movement of the lens assembly 2 along the optical axis O to change the focus or zoom of the image formed on the image sensor 6.

Except as regards the provision of electrically insulating layers as discussed below, the third miniature camera 200 may have the construction described in detail in any one of WO-2007/113478, WO-2008/099156 or WO-2009/056822, which are each incorporated herein by reference, and to which reference is made for a full description of the third miniature camera 200. In general, the third miniature camera 200 may include a single SMA actuator wire 11 or plural SMA actuator wires 11.

In each of the miniature cameras 1, 100 and 200, and as shown in FIG. 6, at least one component 50 of the SMA actuator arrangement 10, that is not the SMA actuator wire 11, is coated with an electrically insulating layer 51. The purpose of the electrically insulating layer 51 is to provide electrical insulation that reduces the risk of a short circuit from current flowing through the SMA actuator wires 11 and other components of the SMA actuator arrangement 10 or 202. Such short circuits could otherwise cause damage to the SMA actuator wires 11. This may in turn allow the SMA actuator wires 11 to be arranged with smaller clearances that may reduce the overall size of the miniature camera 1, 100 or 200.

In general, the component 50 that is coated with an insulating layer 51 may be any component in close proximity to an SMA actuator wire. Some non-limitative examples, which may be coated individually or in any combination, are as follows:

the can 8 that contains the SMA actuator arrangement 10 or 202, which may be coated on its internal surface or over all surfaces;

the support assembly 4 or any part thereof, for example the support block 16 or the support plate 160;

the camera lens assembly 2 or any part thereof, for example the movable platform 15 or the movable platform 150;

the flexure arms 167; or

the balls 175.

Any of such components 50 may be coated with the electrically insulating layer 51 over all its surfaces or over selected surfaces, for example surfaces facing the SMA actuator wires 11. Optionally, all the components of the SMA actuator arrangement 10 or 202 that are not the SMA actuator wire 11 may be coated with the electrically insulating layer 51.

The electrically insulating layer 51 is provided with sufficient thickness to provide electrical insulation, which may depend on the location of the component 50 that is coated. Provided that requirement is met, then the electrically insulating layer 51 may be made as thin as possible so as to minimise possible hindrance of the movement of one component (or assembly) with regard to another. Typically, the thickness of the electrically insulating layer is less than 3 μm, or less than 1 μm. With such a thin coating, it is possible to coat the component 50 without hindering movement.

The electrically insulating layer 51 may be made of any suitable material. An example of a suitable material is Parylene.

The component 50 may be coated with the electrically insulating layer 51 at any stage during the assembly of the miniature camera 1, 100 or 200.

One option is for individual components 50 of the miniature camera 1, 100 or 200 to be coated before assembly.

Another option is for individual components 50 to be assembled into a sub-assembly that is coated prior to the sub-assembly being assembled in the miniature camera 1, 100 or 200.

Another option is for SMA actuator assembly 10 or 202 to be fully assembled and then coated as a whole.

Any suitable process for applying the electrically insulating layer 51 may be used. For example, in the case that the electrically insulating layer 51 is made of Parylene, an example of a suitable application process is powder coating, in which the coating is deposited in a vacuum producing a thin and regular film. In this case, the thickness of the film is of the order of microns, and may be less than 1 μm.

In some embodiments of the miniature cameras 1, 100 and 200, none of the SMA actuator wires 11 are coated with an electrically insulating layer. This provides advantages in the manufacture of the miniature camera, as discussed above.

In other embodiments of the first miniature camera 1, 100 and 200, the or each SMA actuator wire 11 is coated with an further electrically insulating layer 65 as shown in FIG. 7.

The further electrically insulating layer 65 has a thickness that is sufficiently high to prevent electrical breakdown between the wire and any metal surface that it might come into contact with. This depends on the insulation capability of the further electrically insulating layer 65 and the maximum voltages applied to the SMA actuator wires 11 in normal use. In general, the insulation capability of the further electrically insulating layer 65 depends on the type of material used. In air, the breakdown field strength of suitable materials is typically in the region of 3V/μm. Thus, for example, if the further electrically insulating layer 65 extends along part of the length of the SMA actuator wire 11, then a thickness of at least 1 μm might be required to ensure that no breakdown occurs with a 2.8V potential difference. However, if the further electrically insulating layer 65 coats the entire length of the SMA actuator wire 11, then a lower thickness might be sufficient to prevent breakdown.

In typical applications, the further electrically insulating layer 65 has a thickness of at least 0.3 μm, more preferably at least 0.9 μm.

The further electrically insulating layer 65 has a thickness that is sufficiently low to provide a cooling performance that is appropriate to the use in a miniature camera. It might be expected that an electrically insulating layer would reduce the rate of cooling of the SMA actuator wire and hence the speed of extension of the SMA actuator wire, since the thermal insulation provides a thermal resistance, and the electrically insulating layer effectively increases the diameter of the wire, reducing the surface to volume ratio. However, it has been appreciated that an further electrically insulating layer 65 with a relatively low thickness increases the surface area so as to provide the effect of increasing the loss of heat to the surrounding air, which effect compensates for the increase in thermal mass and the increase in thermal resistance arising from the electrically insulating layer. Thus, the rate of cooling is not reduced to the extent that might be expected, and depending on the configuration and materials may be increased. Thus, the further electrically insulating layer 65 has a relatively low thickness such that it permits the high response times needed in a miniature camera.

In typical applications, the further electrically insulating layer 65 has a thickness of at most 10 μm, more preferably at most 5 μm.

The optimal thickness of the further electrically insulating layer 65 in general depends on the material used and the distance to surfaces around the SMA actuator wire 11 that act as a thermal ground and/or provide a risk of shorting.

Various materials are suitable for the further electrically insulating layer 65, some non-limitative examples of which are as follows.

SMA material typically forms an oxide coating of order of 0.1 μm, which thickness is not sufficient to prevent electrical breakdown at 2V-5V. The thickness of this coating can be increased through thermal and chemical treatments to a suitable level, thereby to form the further electrically insulating layer 65.

Alternatively, the further electrically insulating layer 65 may be formed by material applied to the SMA actuator wire 11 during manufacture. Such a material may be applied to the SMA actuator wire 11 on top of an oxide layer, or after removal of the oxide layer so that it is applied directly to the SMA material. Suitable materials that may be applied to form the further electrically insulating layer 65 include, without limitation: polyimide, polyamide, polyurethane, Parylene, polytetrafluoroethylene (PTFE) or any combination thereof.

In general, the further electrically insulating layer 65 may coat the entire length of the SMA actuator wire 11 or a part of the length of the SMA actuator wire 11.

However, a further consideration is the need to achieve good mechanical and electrical contact between the SMA actuator wire 11 and the crimps 17. The further electrically insulating layer 65 may hinder this, especially if it is relatively thick (say, of the order of 1 μm or more) as the mechanical action of closing the jaws of the crimp 17 during manufacture is not sufficient to break down the further electrically insulating layer 65 and make good contact with the SMA material beneath.

To reduce this issue, the SMA actuator wires may be coated with the electrically insulating layer along part of their length, but not at the crimps 17, as shown in FIG. 8. As can be seen, in this example the length 66 of the part of the SMA actuator wire 11 that is not coated with the further electrically insulating layer 65 is greater than the length of contact between the SMA actuator wire 11 and the crimp 17, such that good contact is made within the crimp 17 while providing easy placement of the crimp 17. Leaving a region of the SMA actuator wire 11 outside the crimp 17 uncoated is not an issue, since that region of the SMA actuator wire 11 near the crimp 17 is unlikely to come into shorting contact with any other component. The length of the crimp 17 is typically of the order of 500 μm long, so the uncoated region may typically be up to 1 mm in length.

To achieve partial coating, the further electrically insulating layer 65 may be provided along part of the length of the SMA actuator wire 11 during manufacture by selective coating (for example using a mask prior to coating), or by coating the entire length of the SMA actuator wire 11 and subsequently selectively removing part of the further electrically insulating layer 65. In the latter case, removal of the further electrically insulating layer 65 may be by mechanical abrasion, or other chemical or physical means such as focussed laser or plasma ablation.

Such coating may be performed prior to assembly of the SMA actuator wire 11 into the miniature camera. Good mechanical and electrical contact between the SMA actuator wire 11 and the crimps 17 may be provided by crimping the crimp 17 to the SMA actuator wire 11 after coating by the further electrically insulating layer 65 and subsequently to solder the crimp 17 to the SMA actuator wire 11, for example at the joint where the SMA actuator wire 11 emerges from one side of the crimp 11. Whilst crimping does not break through the electrically insulating wire 65, it nevertheless provides a good mechanical joint, and the solder provides the desired electrical connection. Soldering causes the electrically insulating wire 65 to melt locally exposing the bare SMA actuator wire 11 at the solder site and providing an electrical connection there.

What is claimed is:

1. A miniature camera comprising an SMA actuator arrangement including at least one SMA actuator wire arranged to effect focus, zoom or optical image stabilization of the miniature camera, wherein at least one component of the SMA actuator arrangement that is not the SMA actuator wire is coated with an electrically insulating layer.

2. The miniature camera according to claim 1, wherein the thickness of the electrically insulating layer is less than 3 μm.

3. The miniature camera according to claim 2, wherein the thickness of the electrically insulating layer is less than 1 μm.

4. The miniature camera according to claim 1, wherein said at least one component includes a can containing the SMA actuator arrangement.

5. The miniature camera according to claim 1, wherein the SMA actuator arrangement comprises a support assembly and a camera lens assembly suspended on the support assembly by a suspension system including at least one of flexure arms and bearing balls, said at least one component includes one or more of: the support assembly; the camera lens assembly; the flexure arms, if present; or the bearing balls, if present.

6. The miniature camera according to claim 1, wherein the electrically insulating layer comprises Parylene.

7. The miniature camera according to claim 1, wherein all the components of the SMA actuator arrangement that are not the SMA actuator wire are coated with the electrically insulating layer.

8. The miniature camera according to claim 1, wherein the SMA actuator wire is not coated with an electrically insulating layer.

9. The miniature camera claim 1, wherein the SMA actuator wire is coated with a further electrically insulating layer of thickness in the range from 0.3 μm to 10 μm.

10. The miniature camera according to claim 9, wherein the thickness of the further electrically insulating layer is in the range from 0.9 μm to 5 μm.

11. The miniature camera according to claim 9, wherein the further electrically insulating layer is an oxide layer.

12. The miniature camera according to claim 9, wherein the further electrically insulating layer comprises polyimide, polyamide, polyurethane, Parylene, polytetrafluoroethylene, or any combination thereof.

13. The miniature camera according to claim 9, wherein the SMA actuator wire is coated with the further electrically insulating layer along part of its length.

14. The miniature camera according to claim 13, further comprising crimps arranged to provide electrical and mechanical connections between the SMA actuator wire and the other components of the miniature camera, and the parts of the wire that are not coated with the further electrically insulating layer are at the crimps.

15. The miniature camera according to claim 14, wherein the length of the parts of the SMA actuator wire that is not coated with the further electrically insulating layer are greater than the lengths of contact between the SMA actuator wire and the crimp.

16. The miniature camera according to claim 1, wherein the miniature camera comprises one or more lenses have a diameter of at most 10 mm.

17. The miniature camera according to claim 1, wherein the SMA actuator wire is arranged to effect optical image stabilization.

18. The miniature camera according to claim 17, further comprising:
a support assembly;
an image sensor fixed to the support structure;
a camera lens assembly comprising one or more lenses arranged to focus an image on the image sensor, the camera lens element being supported on the support structure in a manner allowing movement of the camera lens assembly relative to the support assembly across a range of movement in two orthogonal directions perpendicular to the optical axis of the camera lens assembly,
wherein the SMA actuator wire is arranged to drive said movement of the camera lens assembly relative to the support assembly.
